(19) United States
(12) Patent Application Publication
(10) Pub. No.: US 2026/0072417 A1
(43) Pub. Date: Mar. 12, 2026

(54) Universal Ambient AI Neural Field for Buildings (UANF)

(71) Applicant: Samuel Odeh, Burr Ridge, IL (US)

(72) Inventor: Samuel Odeh, Burr Ridge, IL (US)

(21) Appl. No.: 19/390,578

(22) Filed: Nov. 16, 2025

(51) Int. Cl. G05B 15/02; G06N 3/02

(52) U.S. Cl. CPC G05B 15/02; G06N 3/02

(57) ABSTRACT

A building-integrated artificial intelligence system forming a continuous ambient neural field is disclosed. The system includes a distributed multimodal sensor lattice, an on-premise symbolic cognition engine, and an adaptive environmental control kernel operating entirely at the building edge without reliance on external cloud services. Sensor data from optical, thermal, acoustic, airflow, pressure, structural, electrical, and chemical modalities are transformed into non-identifying occupancy vectors, behavioral glyphs, risk indicators, and environmental state descriptors. A privacy-governed policy graph determines sensor permissions, redaction thresholds, consent conditions, emergency overrides, and jurisdiction-specific compliance parameters. The neural field predicts occupancy loads, optimizes HVAC, ventilation, and lighting, detects accidents and structural anomalies, classifies emergent risks, and generates redacted event capsules for audit and emergency dispatch. A federated topology enables multiple buildings to exchange compressed symbolic templates to improve predictive accuracy without transmitting raw data. The system provides a universal, regulation-aligned AI nervous system for autonomous building operations.

[1]A universal ambient AI neural field system for fixed architectural environments comprising:
a distributed array of multimodal sensors embedded within structural surfaces of a building;
a local edge-based symbolic AI processor configured to ingest, classify, and temporally sequence sensory data into a spatial neural field representation;
an event prediction module computing occupancy probability maps, energy consumption vectors, and emergency anomaly risk factors in real-time;
a policy-enforcing actuator module that adjusts environmental subsystems including HVAC, lighting, alarm, and communications based on symbolic outputs;
and a privacy-preserving compliance layer that redacts or blocks transmission of data packets violating preset behavioral, legal, or medical constraints prior to any external data relay or storage operation.

[2] The system of [1], wherein said distributed sensor array includes:
capacitive floor sensors;
acoustic doppler microphones;
ultra-wideband (UWB) motion beacons;
infrared thermal grids;
pressure-sensitive doorframe pads;
and air composition sensors for CO₂, VOC, and NOx levels.

[3] The system of [1], wherein said symbolic AI processor executes a real-time spatiotemporal logic engine with rule-defined behavior segmentation, enabling detection of posture instability, prolonged immobility, disoriented navigation patterns, and unexpected cluster emergence.

[4] The system of [1], wherein the system builds a 3D voxel map of space-time symbolic entities, and calculates risk surfaces based on behavior entropy gradients and deviation from baseline diurnal routines.

[5] The system of [1], wherein emergency state prediction activates when entropy gradients exceed adaptive thresholds set by building-specific behavioral DAGs, triggering preprogrammed alerts to local emergency protocols without cloud involvement.

[6] The system of [1], wherein power is supplied by a hybrid redundant power bus that includes:
a primary building grid tap;
a backup LiFePO₄ battery bank with >96 hours capacity;
and rooftop-integrated PV cells routed through an edge-mounted energy management module.

[7] The system of [1], wherein symbolic logic outputs are logged via a tamper-proof ledger buffer located on-premises in a Faraday-isolated vault node using write-once flash storage.

[8] The system of [1], wherein compliance modules block export of real-time biometric, audio, or positional identifiers unless one of the following holds: (i) an emergency override protocol is activated by the local authority agent; (ii) a court order token is injected; or (iii) occupant consent is granted via authenticated wearable or gesture signal.

[9] The system of [1], wherein the neural field topology continuously adapts its update weightings according to real-time feedback from actuation efficacy, optimizing energy-to-outcome ratios over time.

[10] The system of [1], wherein security anomaly detection is computed through symbolic deviation mapping rather than object tracking or facial identity recognition.

[11]A method for implementing symbolic ambient intelligence within built environments, the method comprising:
deploying an array of spatially distributed sensors embedded in ceilings, walls, and floors of a building envelope;
locally aggregating sensor outputs within a mesh of edge compute nodes;
executing symbolic segmentation logic to convert raw signal vectors into posture-state-action tuples;
constructing time-series event capsules, each tagged with semantic glyphs and risk priority scores;
comparing said capsules against preinstalled behavioral DAG policies to classify normal vs anomalous building use patterns;
and triggering system outputs including: HVAC adjustments, lighting modulation, emergency response preloading, and occupancy-based energy load balancing—
wherein all computation, storage, and actuation occur within the building envelope, absent cloud dependence.

[12] The method of [11], wherein each sensor node synchronizes its timestamp with ±2 ms precision using a local building-wide clock beacon operating at sub-GHz ISM band with redundancy failover.

[13] The method of [11], wherein capsule generation applies:
wavelet decomposition to audio streams;
quaternion smoothing to inertial vectors;
adaptive frame skipping to video input;
and symbolic projection to posture geometry estimates.

[14] The method of [11], wherein behavior glyphs include representations of collapse, erratic pacing, loitering, errant noise bursts, unauthorized zone entry, and static presence outside designated hours.

[15] The method of [11], wherein HVAC output is modulated not by temperature thresholds but by symbolic behavioral entropy of occupants within the active thermal zones.

[16] The method of [11], wherein symbolic capsule chains are retained in secure local buffer memory with hardware lockout from WAN access, and export requires physical access override and dual-consent tokens.

[17] The method of [11], wherein lighting optimization involves dimming, color-temperature tuning, or suppression of zone illumination when no symbolic presence is detected for over an adaptive delay window.

[18] The method of [11], wherein emergency prediction activates “pre-escalation mode” that arms defibrillator access, reconfigures elevator logic to fire protocols, and contacts internal security with capsule-based summary attached.

[19] The method of [11], wherein no personally identifiable information (PII), biometric template, or camera footage is stored beyond a 60-second rolling overwrite window unless a treaty-class anomaly is detected.

[20] The method of [11], wherein zone-level energy drawdowns and renewables buffering are optimized by forecasting motion capsule flows and predicted diurnal symbolic zone entropy.

[21]A building-integrated edge AI node comprising:
a tamper-proof aluminum enclosure housing an SoC (System-on-Chip) configured for symbolic execution;
multiple hardwired input interfaces for audio (electret condenser mic), motion (PIR and ToF), and thermal (thermopile+passive IR grid);
a 2 GB LPDDR4 memory buffer for symbolic capsule chaining;
a redundant dual-core watchdog circuit isolating behavioral anomaly processing from system integrity checks;
and a symbolic glyph generation engine operating on a quantized instruction set with no floating-point dependencies.

[22] The node of [21], wherein the symbolic execution engine converts time-windowed multi-sensor readings into glyph sequences via rule-based vector segmentation, entropy windowing, and context-state alignment.

[23] The node of [21], wherein the enclosure includes vibration-damped heat pipes and EMI shielding compliant with IEC 61000-4-2 and FCC Class B limits for in-wall operation.

[24] The node of [21], wherein memory modules are protected with fused self-destruct traces triggered by thermal, magnetic, or unauthorized access thresholds.

[25] The node of [21], wherein symbolic capsules are generated at a fixed cadence (e.g., 10 Hz) and tagged with local wall-clock timestamps accurate to ±1.5 ms.

[26] The node of [21], wherein redaction logic executes prior to any inter-node communication, ensuring glyph privacy tokens are resolved before network propagation.

[27] The node of [21], further comprising a hardware-coherent emergency override channel that allows priority-based symbolic interrupts (e.g., “collapse,” “flame vector,” “intrusion”) to bypass redaction buffer latency.

[28] The node of [21], wherein lighting control instructions are broadcast over a low-latency CAN bus to ambient drivers, executing symbolic instruction codes such as:
LIT_IDLE, LIT_SOFT_CONSENT, LIT_ZONE_ISO, LIT_SECURITY_ESCALATE.

[29] The node of [21], wherein all firmware and symbolic policy DAGs are updated via physical access only (e.g., via air-gapped USB port inside locked utility panel), and not via over-the-air updates.

[30] The node of [21], wherein each edge device operates in a symbolic mesh network topology, where all glyph transmissions are XOR-obfuscated with shared temporal keys, and decrypted only if local context entropy exceeds a peer-consent threshold.

[31]A method for symbolic environmental sensing in a building comprising:
(a) initializing a mesh of UANF edge nodes, each with thermal, sonic, optical, and proximity inputs;
(b) aggregating raw sensor inputs into symbolic capsule sequences, where each capsule represents a compressed environmental semantic window;
(c) comparing generated capsules to programmable behavioral DAGs stored locally within each node;
(d) executing policy actions if capsule entropy exceeds predefined symbolic thresholds for any critical behavior class (e.g., collapse, aggression, intrusion);
(e) and redacting or suppressing any output that violates consent overlays or privacy class configurations.

[32] The method of [31], wherein capsule comparison uses vector quantization of posture-dynamics, triangulated motion flow, and spectral sound variance across synchronized time-windows of 500 ms.

[33] The method of [31], wherein DAG policy structures are built using consent-scoped YAML logic specifying:

$$symbol ( “ proximity\_intrusion ” ) \to action ( “ LIT\_SECURITY \_ESCALATE ” ) if time\_window < 5 s AND subject\_class \neq \{ staff , maintenance \} .$$

[34] The method of [31], wherein symbolic nodes maintain a rolling entropy score per zone, updated every second, calculated by:

$$E ( t ) = \sum ( ΔC\_i ( t ) / W\_i )$$

where C_i is capsule i's behavioral deviation, and W_i is its normalized context weight.

[35] The method of [31], wherein alerts are delivered over a hardened RS-485 bus, not wireless, and only if the entropy score breaches a consensus-vote threshold across three adjacent nodes.

[36] The method of [31], wherein HVAC optimization signals are generated symbolically and execute only via decoded glyphs like:

$$HVAC\_ZONE \_MODIFY ( “ east ” ) \to SET\_TEMP ( 21.5 °C . ) IF zone\_capsule = “ multi - occupant - rest ” AND air\_quality = “ low\_CO2 . ”$$

[37] The method of [31], further comprising a fallback autonomous mode triggered upon uplink failure, wherein each node maintains its last known DAG state, stores capsule entropy trends for up to 72 hours, and continues redaction without external control.

[38] The method of [31], wherein system-wide behavior trends (e.g., “gradual crowding,” “repeated near-falls,” “unauthorized linger”) are computed through non-identifiable symbolic signature aggregation across 30-minute time intervals.

[39] The method of [31], wherein emergency overrides must be manually co-signed by at least two facility managers via on-site physical consent keys embedded in secure wall consoles.

[40] The method of [31], wherein no biometric identifier (face, fingerprint, gait, voiceprint) is ever stored, transmitted, or embedded into any symbolic capsule.

[41]A symbolic anomaly detection module embedded in each UANF node comprising:
(a) a fixed-size circular buffer of symbolic capsules (length N=180), each encapsulating a 1-second environmental event window;
(b) a pattern deviation analyzer comparing each capsule sequence to localized behavioral DAGs;
(c) a spike-detector subcircuit applying A-symbol entropy change thresholds;
(d) and a severity rank encoder outputting a 4-bit priority glyph ranging from {“benign”, “moderate”, “urgent”, “critical” }.

[42] The module of [41], wherein the deviation analyzer uses symbolic Hamming distance across motif chains to measure anomaly score.

[43] The module of [41], wherein capsules tagged “conflict,” “collapse,” or “intrusion” trigger an immediate local LED glyph flash (color-blind friendly encoded) and optional siren override within 200 ms of detection.

[44] The module of [41], wherein priority glyphs are never stored off-node unless the capsule entropy exceeds a programmable treaty-defined export limit.

[45] The module of [41], wherein false positives are minimized by requiring motif concurrence across three distinct sensor modalities (e.g., sonic+thermal+optical).

[46] The symbolic kernel applies a degradation timer to stale capsules:

$$Entropy ( t ) = {Entropy}_{0} \times e \hat{} ( - λ t )$$

where λ is a decay constant tuned per node zone class.

[47]A symbolic privacy circuit implemented in hardware on each node, the circuit comprising:
(a) an input gate accepting symbolic capsules tagged with zone and occupant class;
(b) a consent map comparator matching against a redaction list stored in volatile RAM;
(c) an eFuse-locked bypass that prevents capsule write if match=true;
(d) and a redacted-log timestamp queue that records all withheld events for regulatory audits.

[48] The circuit of [47], wherein the redaction list is loaded only upon physical token-insertion by a building compliance officer.

[49] The circuit of [47], wherein the eFuse logic is burned post-manufacturing to prevent cloud override access by vendor, administrator, or OEM.

[50] The symbolic kernel supports a zero-knowledge proof interface wherein third-party auditors can validate redaction compliance without decrypting the capsule body.

[51]A consent-based occupancy resolution method performed by each UANF node comprising:
(a) initializing a spatial-symbol buffer covering 8 m radius with 0.5 m² cell resolution;
(b) associating each cell with symbolic signatures: {ambient shift, posture arc, heat delta, vibration tap};
(c) computing a presence confidence score∈[0,1] per cell per second;
(d) and tagging the cell as “active”, “ambiguous”, or “silent” based on programmable thresholds.

[52] The method of [51], wherein the presence confidence score C is computed as:

$$C = {w}_{1} \cdot Δ T + {w}_{2} \cdot motion\_vector \_norm + {w}_{3} \cdot audio\_peak + {w}_{4} \cdot light occlusion$$

where weights w₁ to w₄ are tuned per zone type and user class.

[53] The method of [51], further comprising:
(a) detecting overlapping ambiguous cells;
(b) triggering symbolic triangulation with at least two adjacent nodes;
(c) resolving overlapping tags via capsule majority-vote arbitration.

[54]A fallback privacy mode wherein the node autonomously:
(a) purges symbolic capsule retention buffer if connectivity is lost >90 seconds;
(b) emits local-only alerts via symbolic display and audible chirp;
(c) disables DAG inference beyond 2-hop capsule relations;
(d) and suppresses all off-node transmissions including encrypted telemetry.

[55]A symbolic occupancy DAG (sDAG) instantiated per zone comprising:
(a) root node: entry event tagged with capsule ID and confidence ≥0.8;
(b) internal nodes: behavioral state transitions (e.g., move, sit, idle, stumble);
(c) edge labels: time delta, entropy delta, and gesture glyph code;
(d) and sink node: exit or deactivation with redaction status indicator.

[56] The sDAG of [55], wherein an active zone must maintain at least one leaf-node capsule younger than 300 seconds or it is reset.

[57] The sDAG of [55], wherein an unauthorized zone traversal (e.g., “customer in staff-only”) triggers automatic DAG pruning and alert capsule escalation.

[58] The fallback mode of [54], wherein edge nodes engage in ephemeral peer-to-peer quorum to synchronize redaction logs once power or network is restored.

[59]A symbolic trust register (STR) module per node comprising:
(a) a hashed list of capsule emitters (sensor submodules) and their past deviation scores;
(b) a decaying trust coefficient Tᵢ for each emitter eᵢ;
(c) and a gating function that suppresses emitter input if Tᵢ<programmable floor F.

[60] The STR of [59], wherein trust coefficients are locally recalibrated every 6 hours by computing signal consistency over prior entropy events.

[61]A behavior anomaly detection module (BADM) embedded in each edge node comprising:
(a) a rolling buffer of the last N=120 symbolic capsules;
(b) an entropy score computed per capsule as a function of spatial unpredictability, gesture variance, and duration deviation;
(c) a programmable threshold T above which a capsule is tagged for escalation;
(d) and a pre-alert function that performs capsule diffusion to adjacent nodes for pre-emptive context enrichment.

[62] The entropy score in [61(b)] is defined as:

$$E = {α}_{1} \cdot Δ path + {α}_{2} \cdot Δ posture + {α}_{3} \cdot Δ duration + {α}_{4} \cdot Δ zone$$

where Δ terms represent deviation from zone-specific symbolic means and α₁ . . . α₄ are configurable zone weights.

[63] The module of [61], wherein capsules with entropy≥τ are forked into parallel symbolic DAGs for hypothesis branching, each branch tagged with a probabilistic confidence weight.

[64]A symbolic de-escalation routine comprising:
(a) validating no additional entropy capsule ≥τ was registered within the last Δt seconds;
(b) reducing alert severity from “critical”→“review”→“normal” in DAG metadata;
(c) and redacting observer tags and capsule emitter hashes before retention.

[65]A redaction override rule triggered only by dual consent from:
(a) the STR (Symbolic Trust Register) module and
(b) the policy capsule tree root
wherein override activation permits 30-second retention of high-entropy capsules even in fallback privacy mode.

[66]A symbolic emergency classifier module (SECM) comprising:
(a) a DAG path parser identifying patterns indicative of distress (e.g., collapse, erratic motion, prolonged stillness);
(b) a confidence calculator that fuses sensor reliability, capsule entropy, and pattern severity;
(c) and an autonomous escalation override if confidence ≥0.92 and no human operator responds within 12 seconds.

[67] The classifier of [66], wherein distress patterns are matched via symbolic motif graphs preloaded per building type (residential, commercial, institutional).

[68] The system of [66], further comprising a symbolic responder node (SRN) that:
(a) dispatches capsule summaries to nearest building emergency interface;
(b) overlays symbolic location marker on the facility's internal UI;
(c) and temporarily unlocks encrypted responder-only camera streams for 45 seconds.

[69]A programmable DAG firewall comprising:
(a) node-level rules that restrict capsule traversal across certain symbolic paths (e.g., from “staff private” to “public restroom”);
(b) time-gated edge rules disallowing specific transitions during policy-enforced hours (e.g., 23:00-06:00);
(c) and symbolic masking of path metadata when routes are blocked.

[70] The DAG firewall of [69], wherein violations are encapsulated in hash-signed micro-alerts routed to compliance dashboards via local-only MQTT streams.

[71]A localized symbolic enforcement unit (LSEU) comprising:
(a) a policy logic FPGA configured to interpret YAML-compiled DAG traversal constraints in real time;
(b) a real-time clock (RTC) for enforcing temporal capsule rules;
(c) a hardware-fused rule buffer (HFRB) storing up to 256 enforcement sequences with ≤2 ms read latency;
(d) and a cold-path override relay triggered via signed emergency gesture motifs.

[72] The LSEU of [71], wherein the FPGA supports hot-swappable rulepacks via modular edge firmware capsules authenticated by STR (Symbolic Trust Register) signatures.

[73] An AI-validated symbolic fidelity constraint layer (SFCL) comprising:
(a) a behavior integrity monitor (BIM) checking capsule continuity across sensors;
(b) a symbolic parity matcher comparing behavioral motifs across zones;
(c) and a red flag generator when inconsistent or anomalous capsule merges are detected between nodes operating under identical policy trees.

[74] The BIM of [73], wherein entropy values of adjacent node capsules are compared using:

$$Δ E = \vert Ei - Ej \vert$$

where ΔE>ε triggers automatic capsule rebalance or nullification request.

[75]A symbolic override auditor (SOA) comprising:
(a) override request interface signed by dual-tokens: site-admin and symbolic emergency consensus;
(b) a one-time token signer linked to a local compliance enclave;
(c) and a DAG-diff generator recording the deviation between enforced vs. overridden path for audit trace.

[76]A symbolic redaction engine (SRE) comprising:
(a) a capsule field scrubber removing emitter metadata, vector timestamps, and zone context above severity class 4.0;
(b) a compliance mode selector (CMS) toggling between full, partial, and null retention policies;
(c) and a dropout module that probabilistically excludes high-volume capsule classes (e.g., motion noise) under passive mode.

[77] The redaction engine of [76], wherein dropout probability is computed by:

$$P ( dropout ) = 1 - ( entropy / max\_zone \_entropy )$$

applied to each capsule class tagged as non-priority by policy DAG.

[78]A symbolic DAG router comprising:
(a) a low-latency path parser that preselects 3 candidate symbolic paths per capsule;
(b) an adaptive path scheduler using real-time motif frequency heatmaps;
(c) and a probabilistic drop mechanism when DAG node saturation exceeds preset thresholds.

[79] The router of [78], wherein the adaptive scheduler uses a token bucket-style fairness limiter to avoid oversampling of high-traffic behavioral motifs.

[80]A system of symbolic DAG compression operating over edge-only consensus, wherein:
(a) redundant motif branches are pruned by comparing edge hash vectors;
(b) identical subtrees are collapsed under single tags with reproducible hash ancestry;
(c) and privacy rules prevent subtree export if it contains more than 3 unique staff-customer interaction motifs in <10 min window.

[81] An ambient sensor fusion array (ASFA) comprising:
(a) a synchronized grid of multimodal sensors including thermal, acoustic, electromagnetic field, and ultralow frequency vibration detectors;
(b) a signal aggregator with 1 ms sampling granularity;
(c) and an envelope extractor that constructs ambient activity contours across spatiotemporal grid sectors.

[82] The ASFA of [81], wherein thermal thresholds above 2.3° C. differential across a 5-second window within a 2 m radius trigger a symbolic capsule of class “anomaly:thermal-climb”.

[83] The ASFA of [81], wherein ultralow frequency detection below 20 Hz maps capsule classes such as “proximity:heavy-walk” or “impact:floor-vibration” depending on resonance profile.

[84]A DAG enforcement engine configured to:
(a) traverse symbolic behavioral capsule paths through policy DAGs with active node-class modifiers;
(b) drop capsules when policy flow terminates in null;
(c) or escalate when leaf node is tagged as escalate:zone_X.

[85] The DAG engine of [84], wherein each policy DAG includes version hash metadata, priority tags, and consent-tier access filters applied at enforcement time.

[86]A temporal zoning subsystem (TZS) comprising:
(a) a dynamic zone map partitioning the floor plan into temporal activity buckets using recent occupancy and motion data;
(b) a zone hash generator that tags each zone capsule with time-encoded vector fingerprint;
(c) and a temporal anomaly detector that flags violations such as presence-in-restricted-zone-after-hours.

[87] The TZS of [86], wherein zone transitions are represented as Markov state transitions between symbolic states Zᵢ→Zⱼ with associated transition confidence matrix:

$${T}_{ij} = P ( {Z}_{j} \vert {Z}_{i} , t )$$

where t is the timestamp context.

[88]A symbolic redaction scheduler (SRS) configured to:
(a) redact capsules by motif, severity class, and zone-context;
(b) schedule retention window decay by capsule class;
(c) and enforce probabilistic egress window flushing to external analytics nodes under encryption.

[89] The SRS of [88], wherein capsule retention is defined as:

$$R = f ( {c}_{i} , {s}_{j} , {z}_{k} , t )$$

where cᵢ=capsule type,
sⱼ=severity,
zₖ=zone context,
t=time-since-capture,
and R<ε→drop capsule from store buffer.

[90]A multi-zone arbitration module (MZAM) comprising:
(a) a DAG overlay composer that merges policy DAGs from adjacent zones;
(b) a conflict resolver that selects highest-priority rule across merged branches;
(c) and a capsule router that reassigns capture to dominant zone in event of zone-boundary conflict.

[91]A memory-mapped symbolic capsule register comprising:
(a) a header block encoding capture time T, origin sensor ID Sᵢ, and zone ID Zⱼ;
(b) a symbolic payload block containing compressed motif hash, severity class, and DAG path UUID;
(c) and a capsule lifecycle pointer stack encoding the transition states [captured, classified, retained, redacted, flushed].

[92] The capsule register of [91], wherein motif hash is computed via SHA-512 on a serialized sequence:

$$H = SHA - 512 ( {s}_{1} ‖ {m}_{1} ‖ {z}_{1} ‖ {t}_{1} )$$

where s₁=sensor vector,
m₁=motif label,
z₁=zone ID,
t₁=timestamp.

[93] An emergency override logic circuit (EOLC) configured to:
(a) receive edge-triggered interrupt inputs from fire, security, or medical alert pins;
(b) inject override flags into capsule headers forcing transmission to designated emergency DAG branch regardless of consent flag state;
(c) and enforce redaction bypass in accordance with legal threshold class “emergency-elevated”.

[94] The EOLC of [93], wherein override flags take priority over DAG-defined capsule routing if:

$$P ( emergency ) \times R ( capsule ) > τ\_crit$$

where P(emergency)=probability of verified emergency,
R(capsule)=capsule severity score,
and τ_crit=policy-defined override threshold constant.

[95]A decentralized DAG versioning system (DDVS) comprising:
(a) local DAG replicas stored at each edge node;
(b) a version anchor mechanism using hash-linked commit identifiers (CID);
(c) a consensus update protocol based on DAG propagation triggers and local quorum votes.

[96] The DDVS of [95], wherein DAG updates occur only when:

$$Majority ( Hash ( {DAG\_v}_{n} ) ) \neq Hash ( {DAG\_v}_{{n}^{- 1}} )$$

and a quorum certificate QCᵢ is signed by ≥2/3 nodes in the zone mesh.

[97]A DAG rollback handler configured to:
(a) detect inconsistencies in DAG execution paths across zones;
(b) invalidate any capsule path traced through an inconsistent DAG version;
(c) and issue rollback notification capsules to reconcile local state.

[98] The rollback handler of [97], wherein rollback is constrained by:

$$Rollback\_Window = [ {t}_{n} - Δ , {t}_{n} ]$$

$$Δ \leq max DAG retention time \times policy factor .$$

[99]A cryptographic audit log writer comprising:
(a) capsule commit log indexed by DAG ID and motif path;
(b) zone-specific Merkle root anchors for log bundles;
(c) and an optional off-chain replication queue for compliance export.

[100] The log writer of [99], wherein the compliance export includes:
DAG hash
capsule class summary
zone entropy metrics
redaction decision logs
all stored in a signed, append-only encrypted JSON bundle.

[101]A symbolic entropy engine (SEE) configured to:
(a) monitor motif variety across time windows;
(b) compute entropy vector E_z(t) per zone z using:

$$E\_z ( t ) = - \sum P ( {m}_{i} , z , t ) \times {log}_{2} ( P ( {m}_{i} , z , t ) )$$

where P(mᵢ, z, t) is the empirical probability of motif mᵢ in zone z during time window t.

[102] The entropy engine of [101], wherein entropy delta ΔE is used as a trigger threshold for anomaly alerts if:

$$\vert E\_z ( {t}_{n} ) - E\_z ( {t}_{{n}^{- 1}} ) \vert > θ\_ entropy$$

where θ_entropy is a programmable zone-specific deviation limit.

[103]A zone-level HVAC integration controller (ZHIC) configured to:
(a) receive real-time zone occupancy vector O_z
(b) fetch symbolic activity class A_z from capsule flow;
(c) and optimize HVAC actuator states via:

$$HVAC\_cmd = f ( O\_z , A\_z , E\_z ( t ) , external\_temp )$$

where f is a closed-form energy minimization solver with comfort constraints.

[104] The controller of [103], wherein HVAC setpoint A is computed based on:

```
If A_z ∈ [“motion-intense”, “high-density”], then
  Temp_setpoint ← Temp_baseline − δ
Else
  Temp_setpoint ← Temp_baseline
```

where δ is a programmable thermal adjustment coefficient.

[105]A gesture-response safety protocol (GRSP) comprising:
(a) real-time detection of predefined emergency gestures (e.g., arm wave, collapse, sprinting);
(b) symbolic tagging into emergency DAG path E_path;
(c) activation of soft alarm relay and capsule pinning in memory.

[106] The GRSP of [105], wherein gesture classification confidence C_g must exceed:

$$C\_g \geq τ\_safe \_gesture$$

before triggering alert capsule generation.

[107]A privacy-aware power manager (PAPM) configured to:
(a) profile energy usage of symbolic processing units;
(b) schedule low-entropy zones for partial compute suspension;
(c) and enforce blackout logic for private zones during idle windows.

[108] The power manager of [107], wherein power down schedule is encoded as:

$$P\_z ( t ) =$$

$$\{ full\_power , if E\_z ( t ) > ε\_high$$

$$idle\_mode , if E\_z ( t ) < ε\_low and t ∈ night\_window$$

$$blackout\_mode , if zone\_flag = “ private ” \}$$

[109]A supercapacitor-backed buffer system configured to:
(a) flush volatile capsule memory upon primary power loss;
(b) trigger hash commit of last 100 capsules;
(c) and update rollback register with emergency flag.

[110] The system of [109], wherein flush time T_flush≤20 ms and ensures non-loss of event-critical capsules captured up to T_now−1 s.

[111]A symbolic DAG compiler (SDC) configured to:
(a) receive behavioral glyphs from SRL capsule stream;
(b) apply motif-binding heuristics to infer event chains;
(c) construct a Directed Acyclic Graph G_behavior per zone per hour, wherein:

$$G\_behavior = ( V , E ) ,$$

$$V = \{ {m}_{1} , {m}_{2} , … , {m}_{n} \} = symbolic motifs$$

$$E = \{ ( {m}_{i} \to {m}_{j} ) \vert sequence prob \cdot P \geq θ\_bind \}$$

[112] The DAG compiler of [111], wherein edges are pruned periodically based on entropy stagnation using:
if ∂E/∂t<ε_decay for τ_window, then prune edge (mᵢ→mⱼ)

[113]A zone consensus mesh protocol (ZCMP) configured to:
(a) assign each room or defined spatial cluster a ZID (zone identifier);
(b) facilitate peer-to-peer state propagation using:
   Z₁.state→f(Z₂.state,Z₃.Δcapsule, . . . Zn.context)
   where f is a weighted majority resolver using latency-adjusted trust scores.

[114] The protocol of [113], wherein trust decay occurs if a zone fails to sync for T_fail≥30 s. after which it is marked degraded and enters symbolic quarantine.

[115] An adaptive privacy filter matrix (APFM) comprising:
(a) per-zone filter weights W_privacy(z, t)
(b) dynamic adjustment rule set R_privacy such that:

```
if zone activity type = “employee-only” and behavior = “idle”, then
  W_privacy(z) += λ_idle_protect
if symbolic_conflict motif appears in G_behavior(z), then
  W_privacy(z) −= μ_conflict_alert
```

[116] The matrix of [115], wherein redaction severity R_s is calculated by:

$$R\_s ( z , t ) = σ ( W\_privacy ( z , t ) )$$

where σ is a sigmoid remapping for threshold enforcement

[117]A thermal-behavior correlation engine (TBCE) configured to:
(a) log 3D thermal pixel arrays per unit time
(b) associate thermal flux vector T_flux with symbolic activity A_t
(c) emit alert if:
   T_flux>Δ_T_threshΛA_t∈[“still”, “collapsed”, “lying prone”]

[118] The TBCE of [117], wherein outlier behavior is flagged if inverse coupling observed between audio activity and thermal increase:
if Audio_level(t)<θ_audio_lowΛT_flux>Δ_T_thresh→potential distress

[119]A symbolic privacy tier escalator (SPTE) configured to:
(a) evaluate building-wide redaction class R_building;
(b) override local settings in cases of symbolic emergency events (fire, violence, structural breach);
(c) enforce max privacy grade drop of one level per 30 seconds post-alert.

[120]A Local Symbolic Consent Registry (LSCR) comprising:
(a) a per-occupant symbolic ID table SID table containing:

$$SID\_i = \{ type , consent\_level , active\_times , zones\_authorized \}$$

(b) a lookup interface for referencing SID_i during SRL capsule evaluation;
(c) a compliance handler which suppresses capsule activation if:

$$SID\_i \cdot consent\_level < action\_threshold ∧ zone ∉ SID\_i \cdot zones\_authorized$$

[121] The LSCR of [120], wherein symbolic IDs are generated via non-biometric stochastic hash from movement vectors, thermal signature gradients, and acoustic gait profiles, with uniqueness enforced through Hamming radius separation.

[122]A fault-tolerant DAG storage subsystem configured to:
(a) serialize G_behavior(z, t) as a compact JSON-delta chain:

$$G\_t + 1 = G\_t ⊕ Δ\_t$$

(b) replicate each delta chain across k=3 non-cloud edge nodes using:
   Write(Gᵢ)→ACK majority from N₁, N₂, N₃

[123] The storage system of [122], wherein symbolic compression is applied to redundant DAG motifs via reference hashing:
if hash(M₁)=hash(M₂), store once with pointer table.

[124] An external policy cartridge (EPC) module, comprising:
(a) a pluggable hardware interface supporting YAML policy trees
(b) hot-swappable logic overlays controlling behavior-tag thresholds, escalation triggers, consent rules
(c) jurisdiction-lock function preventing operation without authenticated regional config.

[125] The EPC of [124], wherein cartridge insertion triggers:
SHA-256 signature validation
   regional zoning alignment
   LSCR rebinding
   DAG motif reweighting within 3 seconds

[126]A visual-to-symbolic feedback overlay system (VSFO), comprising:
(a) an encrypted local visual interface (e.g., wall panel, e-ink tablet, mobile AR)
(b) dynamic overlay of symbolic glyphs atop real-time views, sourced from current G_behavior(z, t)
(c) gesture-based glyph dismissal or annotation.

[127] The VSFO of [126], wherein only glyphs linked to user's SID permission class are rendered, with overlays redacted if W_privacy(z, t)>θ_privacy.

[128]A haptic+symbolic alert fusion mechanism optionally integrated with VSFO, configured to vibrate or signal via acoustic cue when symbolic risk exceeds escalation margin:

$$if R\_s ( z , t ) + Δ\_risk > φ\_alert \to emit feedback$$

[129]A symbolic anomaly fusion engine (SAFE), comprising:
(a) multi-stream symbolic input ports for behavior graphs G_behavior(z, t), thermal gradients T_field(x, y, t), and acoustic anomalies A_dB(x, t);
(b) a fusion processor applying time-windowed symbolic matching:

$$S\_fused = f ( G , T , A ) if Δ t \leq τ\_fusion$$

(c) anomaly scoring vector a(z, t) computed as:
   α(z, t)=Σ[wᵢ·δᵢ(z, t)] over all modality deltas

[130] The fusion engine of [129], wherein weights wᵢ are dynamically adjusted using reinforcement loops from downstream emergency DAG triggers.

[131]A symbolic emergency override DAG (SEOD), comprising:
(a) hierarchical DAG with nodes Nᵢ={risk_class, location_zone, consent_gate, action_plan};
(b) activation edge Eᵢⱼ triggered when α(z, t)>thresholdᵢ
(c) action_plan enforced through programmable logic controller (PLC) interface for:
   lockdown
   ventilation override
   voice alert
   emergency lighting

[132] The SEOD of [131], wherein consent_gate field must validate:
SID_i.policy∈{override_approved}
VG_behavior(z, t)∈{fall_detected, conflict, unconscious}

[133] An adaptive HVAC modulation layer controlled by symbolic inference engine, comprising:
(a)

$$symbolic occupant state vector O\_state ( z , t ) = \{ presence , activity\_level , temp\_preference \}$$

(b) delta compressor computing:

$$Δ H = f ( O\_state ⋃ T\_field ( x , y , t ) )$$

(c) actuator control relay executing H_new(x, y, t) via BACnet or KNX protocol.

[134] The modulation of [133], wherein symbolic HVAC commands are overridden when DAG escalation node N_emergency=TRUE.

[135]A zero-knowledge proof (ZKP) integration module for SRL-DAG outputs, comprising:
(a) zk-SNARK proof generator for:
   “Symbolic behavior matched risk class rᵢ”
   “Consent token applied before alert”
(b) verification circuit embedded in redaction layer, producing:
   π=Proof{risk, consent, redaction}
   validated by external verifier V without revealing SID_i or raw data

[136] The ZKP module of [135], wherein proof size is <1 KB and verification time <20 ms on RISC-V secure enclave.

[137]A fallback symbolic tagging pipeline that defaults to post-event ZKP if real-time pipeline is interrupted, anchoring all reconstructed G_behavior(z, t) graphs with audit ledger hashes.

[138]A redacted analytics dashboard subsystem, comprising:
(a) symbolic metrics vector S_analytics(t) including:
   total occupancy count N_occ(t)
   anomaly incidence rate λ_anomaly(t)
   energy deviation delta ΔE(t)
   privacy redaction rate ρ_redact(t)
(b) a display rendering engine applying redaction overlay R_mask(x, t) prior to GUI output, such that:
   RenderedMetricᵢ=Sᵢ if consent_policyᵢ=TRUE, else NULL.

[139] The subsystem of [138], further comprising export modules to insurance, compliance, and maintenance dashboards via zero-knowledge proof π(Sᵢ) attached to each field.

[140]A tenant-admin symbolic policy partitioning engine comprising:
(a) policy DAG D_tenant and D_admin with disjoint override privileges;
(b) local SID lookup engine tagging each behavioral capsule Cᵢ with namespace scope E {tenant, admin};
(c) conflict resolver that enforces admin_policy∩tenant_policy=Ø unless arbitration token α_overrule=TRUE.

[141] The partitioning engine of [140], wherein arbitration is recorded via a signed ledger entry by both parties using ECDSA sig admin, sig_tenant.

[142]A symbolic fire evacuation routing system, comprising:
(a) local symbolic behavior map G_behavior(z, t) overlaid with fire hazard nodes F(x, y, t);
(b) vector field calculator producing ∇_evac(x, y, t) avoiding F(x, y, t)∨locked_zone(x);
(c) directional light actuator control system which pulses pathway segments according to ∇_evac.

[143] The system of [142], wherein symbolic occupancy graphs are dynamically thinned to exclude known trapped nodes or disabled individuals requiring staff assist.

[144]A consent-bound lighting modulation system comprising:
(a) symbolic light preference map L_pref(z, t) per occupant SIDᵢ;
(b) global envelope function:

$$L\_final ( x , y , t ) = {\sum }_{i} {W}_{i} \cdot {L\_pref}_{i} ( x , y , t ) \cdot {Consent}_{i}$$

$$where \sum {W}_{i} = 1 and {Consent}_{i} = TRUE$$

(c) photon emission control subsystem that actuates lighting zones to L_final only after verifying Consentᵢ=TRUE on all intersecting users.

[145] The lighting system of [144], wherein fallback defaults to L_min_safe if consent cannot be verified in under 200 ms.

[146]A secure symbolic override token mechanism for emergency services, wherein:
(a) symbol-token ζ emergency is generated with:
   physical presence detection of emergency personnel
   badge RFID proximity signature
   embedded nonce generation from enclave hash
(b) Upon ζ emergency detection, all DAG privacy filters are suspended under conditional timer i_emergency<15 min unless manually extended.

[147]A symbolic water leak detection system, comprising:
(a) an acoustic sensor array S_acoustic(x, t) tuned to subsonic flow turbulence;
(b) a symbolic anomaly classifier C_leak(t) that detects divergence between expected and actual pipe resonance signatures via:

$$ΔΨ ( t ) = \vert Ψ\_expected ( t ) - Ψ\_measured ( t ) \vert > θ\_leak$$

(c) leak class tagging system: Li E {microleak, persistent, catastrophic};
(d) corresponding DAG output to maintenance dispatcher and redacted risk dashboard.

[148] The system of [147], wherein symbolic alerts are only escalated when consensus DAG branches agree on leak classification confidence >95%.

[149]A symbolic air toxicity detection system comprising:
(a) gas sensor multiplex S_gas(t) (CO₂, CO, VOCs, PM2.5, PM10, NH₃);
(b) symbolic inference engine T_toxic(t) which creates behavior-weighted risk capsule:

$${Risk}_{i} = f ( {concentration\_gas}_{i} , {human\_behavior}_{i} , {ventilation\_rate}_{i} )$$

(c) capsule routing policy where Riskᵢ>λ triggers DAG branch alert, red light path overlay, and isolation vent commands.

[150] The system of [149], wherein all sensor inputs are symbolized and no raw data is stored post-capsule DAG resolution (t>τ_resolution).

[151]A symbolic appliance schedule optimizer comprising:
(a) real-time energy rate fetcher E_grid(t);
(b) symbolic user-appliance intent DAGs D_useᵢ (e.g., laundry, oven, HVAC, charger);
(c) optimizer which assigns execution slot Tᵢ minimizing:

$$Cost ( {T}_{i} ) = \int E\_grid ( t ) \times {Appliance}_{i} \_load ( t ) dt$$

$$Subject to : consent ( {T}_{i} ) = TRUE$$

[152] The optimizer of [151], wherein appliance tokens are scheduled using quorum agreement between user DAG D_user, energy policy DAG D_energy, and safety DAG D_safety.

[153]A multi-tenant symbolic billing abstraction system, comprising:
(a) tenant DAGs D_tenantᵢ and appliance-event graphs A_eventᵢ;
(b) symbolic attribution engine mapping shared usage nodes to per-tenant symbolic weights Wᵢ, such that:

$${Bill}_{i} = \sum {W}_{i} \times {Event\_Energy}_{i} \times Rate\_Energy ( t )$$

(c) privacy-preserving layer encrypting per-tenant capsules C₁ with ZK-proof π_bill to enable verifiable billing without raw trace exposure.

[154] The system of [153], wherein tenants may audit shared consumption graphs through a symbolic navigator UI filtered by namespace.

[155]A fallback DAG state reconstruction logic, comprising:
(a) persistent DAG cache in signed enclave memory;
(b) DAG replay journal Jᵢ={ΔDᵢ(t₀→tₙ)};
(c) symbolic reconciliation node that replays valid branches post-power loss or malicious capsule corruption.

[156] The fallback system of [155], wherein symbolic recomputation preserves timestamped risk and consent states, even without original behavioral telemetry.

[157]A symbolic occupancy inference system comprising:
(a) multimodal sensor fusion S_multi(t)={audio, ToF, pressure, thermal, motion};
(b) occupancy capsule builder C_occ(t) that classifies occupancy into:
   Occₜ∈{Unoccupied, Transient, Occupied, Overoccupied, Unauthorized}
(c) DAG overlay D_occ(t) embedded with threshold triggers, zoning tags, and risk weight vectors.

[158] The system of [157], wherein the occupancy DAG D_occ includes a “ghost mode” classifier for unaccompanied motion in off-hours scenarios.

[159]A real-time insurance compliance capsule system, comprising:
(a) safety event logger E_safety(t) symbolizing slips, smoke, fall trajectories, and human-object collisions;
(b) policy DAG loader D_ins(t) from insurer contract nodes;
(c) capsule generator C_ins(t) signed with hashed event trace H(t) and embedded ZK-proof π_compliance;
(d) capsule relay to insurer when policy DAG thresholds θ_ins are breached.

[160] The system of [159], wherein DAG branches encode insurer-specific exemptions and limit clauses without exposing raw tenant motion.

[161]A symbolic zoning compliance abstraction system comprising:
(a) legal zoning code parser Z_code(x) producing structured nodes from natural language clauses;
(b) symbolic mapper M_zone(x, y) linking architectural layout to zoning policy via DAG anchors;
(c) dynamic alert system for violations such as:
   improper lighting density
   ventilation flow minimums
   emergency exit obstruction
   over-occupancy by zone tag

[162] The system of [161], wherein each policy violation spawns a symbolic audit token T_auditᵢ for building manager and legal counsel.

[163]A tenant-specific safety DAG orchestrator comprising:
(a) unique DAG instance D_tenantᵢ(t) per lease agreement;
(b) event filters Fᵢ scoped to the leased zones and hours of operation;
(c) symbolic overlay with obligations such as:
   chemical storage detection
   electrical surge risk
   flammable inventory tracking
(d) symbolic escrow of DAG updates via building-wide DAG D_building(t).

[164] The orchestrator of [163], wherein cross-tenant DAG branches synchronize through encrypted capsule exchanges validated via edge timestamp oracle O_time.

[165]A symbolic alert suppression module comprising:
(a) privacy DAG overlays D_privacy; per tenant request;
(b) redaction DAG D_redact(t) prioritizing occupant consent tokens T^{c};
(c) final alert DAG D_final(t)=intersect(D_policy, D_tenant, D_privacy) excluding all subgraphs blocked by −T^{c}.

[166] The suppression module of [165], wherein all alert logs remain DAG-traceable for future post-incident arbitration, but are not exposed in real time.

[167]A symbolic fire response DAG engine comprising:
(a) event detector F_event(t) detecting temperature spike+chemical signature anomaly;
(b) capsule branch C_fire(t) triggered via multi-sensor correlation (smoke+IR+occupancy vectors);
(c) DAG D_fire(t) representing evacuation topology, response delay nodes, and exit path congestion scoring;
(d) real-time redaction of unrelated occupant motion branches to preserve consent logic.

[168] The system of [167], wherein D_fire transmits capsule overlays to building responders with symbolic motion channels, not camera footage.

[169]A privacy-compliant load-shedding ethics layer comprising:
(a) symbolic building-wide energy load DAG D_energy(t);
(b) occupant consent matrix M_consent(x, y) with tiered priority weights;
(c) ethics engine E_shed(t) optimizing load drop path such that:
   minimize(P_disruption)
   subject to ΣPᵢ_drop≤Threshold
   AND ∀x∈Occupants: Pᵢ_drop∈Acceptable(x)

[170] The ethics layer of [169], wherein classrooms, ICUs, and elder-care rooms have hard redaction constraints in M_consent.

[171]A symbolic ambient context modeler, comprising:
(a) sensor graph G_sensors(t) dynamically weighted by entropy rate and consent priority;
(b) ambient DAG D_context(t) encoding time-of-day, foot traffic heatmaps, occupancy density, and sound envelope changes;
(c) behavior prediction module B_predict(t+Δ) forecasting mood, stress, and crowding symbols 5-60 seconds ahead.

[172] The modeler of [171], wherein D_context triggers early lighting adjustments, ventilation shifts, or soft alerts prior to behavior deviation exceeding threshold Θ_context.

[173]A symbolic acoustic reasoning system comprising:
(a) passive microphone mesh M_acoustic(t) with ultrasonic+sub-vocal spectrum capture;
(b) acoustic symbolizer S_acoustic(t) generating abstract symbols for impact, distress tone, verbal escalation, silence anomalies;
(c) privacy filter F_acoustic enforcing hard blocks on lexical content, emotional tone exposure, and speaker identity.

[174] The system of [173], wherein escalations such as shouting trigger symbolic alerts only if:
no other consented sensor confirms
the space is shared
the symbolic token threshold for event class Aggressive is met

[175]A symbolic DAG coalescence module that merges fire, energy, and behavior DAGs into a real-time unified policy topology D_unified(t), scoped by:
occupancy zone overlays
legal zoning policy imports
contract-bound suppression tokens

[176] The system of [175], wherein D_unified can snapshot any event branch, output π_chainproof, and submit it into a compliance ledger, without ever reconstructing raw sensor inputs.

[177]A symbolic visitor management system comprising:
(a) visitor class tokens V_token(x) generated via entrance capsule without ID binding;
(b) dynamic DAG D_guest(t) scoping path access, symbolic trust level, and event eligibility;
(c) purge scheduler P_expiry(t) which deletes guest symbols after Δt unless consent-based extension is received.

[178] The system of [177], wherein visitor trajectories are tagged as “volatile” and redacted upon crossing threshold Θ_proximity to private zones.

[179]A gesture-only symbolic control interface comprising:
(a) localized motion DAG D_gesture(t) computed from ToF+posture delta vectors;
(b) symbolic command encoder C_sym(x) matching motion arcs to permissioned function capsules (e.g., unlock, summon, dim, silence);
(c) consent-bounded execution path constrained by zone classification and role token.

[180] The interface of [179], wherein occupants with class Maintenance or Healthcare may issue override gestures only when gesture entropy E(x) is <threshold and no conflicting gestures exist within T seconds.

[181]A symbolic HVAC orchestration engine comprising:
(a) building thermal DAG D_thermal(t) constructed from room zones, sensor curves, and occupancy predictions;
(b) symbolic goal state G temp(t) defined by comfort token+sustainability weights;
(c) actuator overlay A_HVAC(t) that modulates fans, ducts, vents, and cooling fluid valves via symbolic path logic.

[182] The system of [181], wherein the HVAC DAG integrates entropy suppression logic to delay actuation during uncertain occupancy classification.

[183]A symbolic lighting DAG controller comprising:
(a) light node map L_map(x,y,z) with lux output gradients, motion adjacency weighting, and window exposure class;
(b) symbolic ambient flow DAG D_light(t) evolving based on time, presence, and sentiment indicators (from symbolic capsule consensus);
(c) symbolic override vector V_override(t) engaged when conflict between privacy capsule and ambient goal exceeds delta δ_privacy.

[184] The controller of [183], wherein any lighting state change over ΔL>15% must first compute symbolic displacement entropy to prevent startling occupants in class Elder, Child, or Medical.

[185]A symbolic simulation environment for predictive behavior modeling comprising:
(a) DAG simulator Sim_DAG(t+A) executing forward-symbol expansions across gesture, audio, thermal, and occupancy motifs;
(b) token-seeded virtual agents A_sim(x) replicating symbolic behavior from prior capsules;
(c) scoring module S_safety(x) to measure projected collisions, consent violations, or symbolic conflicts.

[186] The simulator of [185], wherein A_sim(x) are constrained to symbolic entropy limits and do not inherit any biometric traceability.

[187]A symbolic elevator governance system comprising:
(a) floor-class DAG D_floor(x) defining access privileges, temporal constraints, and occupancy caps per symbolic role;
(b) real-time capsule overlay C_elev(x,t) matching passenger motifs to permissioned floor transitions;
(c) override submodule O_emergency(x) triggered only by verified symbolic distress capsules, bypassing all token gates.

[188] The system of [187], wherein if occupancy entropy H_occ>threshold, elevator holds or reroutes to neutral lobby floor until resolution.

[189]A multi-zone symbolic capsule arbitration engine comprising:
(a) zone DAG D_zone(x,y) mapping intersecting symbolic capsules across retail, residential, and medical domains;
(b) arbitration matrix A_matrix(x) assigning priority resolution based on symbolic conflict class (e.g., intrusion, collision, consent-break);
(c) conflict entropy calculator E_conflict(x,y,t) to halt, resolve, or quarantine capsule bundles before further execution.

[190] The engine of [189], wherein arbitration occurs edge-local at inter-zone routers without invoking cloud decision-making.

[191]A wearable haptic consent overlay system comprising:
(a) consent glyph engine G_consent(x) projecting symbolic role via LED, e-ink, or chromatic display surface;
(b) haptic feedback loop H_feedback(x) delivering warning or confirmation pulses on consent threshold shifts;
(c) override gesture capture G_override(x) requiring high-confidence biometric-free posture sequence for activation.

[192] The system of [191], wherein emergency escalation signals require dual-confirmation:

$$symbolic path + time - pressure haptic double - pulse .$$

[193]A symbolic emergency ethics DAG system comprising:
(a) ethics DAG D_ethics(t) branched by priority class (fire, violence, fall, anomaly);
(b) symbolic route resolver R_escape(x,y) determining safest egress across zone DAG with trust-weighted routing;
(c) public broadcast capsule generator C_broadcast(t) emitting minimal-identification warnings for occupants in uncertainty zones.

[194] The system of [193], wherein DAG branches under ethical stress must log path-switches with hash-signed audit frames within 1 second of resolution.

[195] The system of [193], further comprising compliance agent A_compliance(x) that scores emergency capsule paths based on prior rehearsal entropy, policy fit, and symbolic casualty cost gradient.

[196]A symbolic building maintenance DAG system comprising:
(a) a multi-zone sensor fusion engine S_maint(x) ingesting temperature, vibration, acoustic resonance, and humidity vectors;
(b) a fault-prediction DAG D_fault(x) constructed from symbolic degradation patterns associated with entropy rates over time;
(c) a symbolic alert generator A_alert(x) that issues glyph-based maintenance warnings based on pre-failure thresholds without revealing occupant behavior.

[197] The system of [196], wherein alerts are ranked using a degradation-trust score derived from cross-zone motif similarity.

[198]A thermal leak forecasting module comprising:
(a) symbolic thermal differential capture T_diff(x,y,t) across paired zones with energy delta correlation;
(b) entropy-based material strain estimator E_material(x,t) modeling leak probability based on insulation decay motifs;
(c) a symbolic reinforcement layer R_thermal(t) adapting DAG thresholds as seasonal or occupancy dynamics evolve.

[199] The module of [198], wherein sustained entropy above policy thresholds auto-triggers low-energy HVAC compensation capsule before leak verification completes.

[200]A gesture-based emergency override unlock system comprising:
(a) a gesture recognition module G emergency(x) mapping posture trajectories against whitelist DAGs with no biometric dependence;
(b) a consent-verification capsule C gesture(t) that checks role-class consistency before granting unlock command;
(c) a redundancy lock circuit L_fail(x) requiring capsule co-sign from adjacent node if ambiguity or mismatch occurs.

[201] The system of [200], wherein override gestures must complete within temporal gesture window T_g<3 s or session expires.

[202]A zero-knowledge proof (ZKP) logging system for symbolic building events, comprising:
(a) an activity anonymizer A_mask(x) that strips path and role identifiers while preserving symbolic intent class;
(b) a zk-SNARK circuit Z_log(t) that generates cryptographic proof of capsule sequence validity without revealing raw telemetry;
(c) a ledger anchor L_zkp(t) that timestamps symbolic events into regulatory audit chain with jurisdictional separation.

[203] The system of [202], wherein each symbolic event capsule includes hash of its ZKP audit proof embedded inline with DAG output.

[204] The system of [202], further comprising a verification engine V_juris(x) that tests policy-aligned redaction probability bounds per region and flags anomalies.

[205]A symbolic HVAC optimization system comprising:
(a) a zone-sensed symbolic DAG D_HVAC(x) that maps occupancy, entropy, and external climate vectors to predictive thermal regulation instructions;
(b) a modifier engine M_adapt(t) that reconfigures HVAC operation thresholds based on gesture-derived occupant comfort patterns;
(c) a latent thermal capsule C_HVAC(x,t) representing pre-failure compressor risk, symbolic airflow obstructions, and maintenance deferment sequences.

[206] The system of [205], wherein DAG edge weights are rebalanced using energy market rates and daylight exposure angles per building facade.

[207]A perceptual privacy enforcement engine comprising:
(a) a symbolic masking layer P_mask(x) that dynamically alters capsule visibility and sensor resolution when subject enters policy-defined privacy state;
(b) a DAG D_context(x,t) that verifies posture, intent glyphs, and trajectory match against private-state signature motifs;
(c) a redaction sequencer R_enforce(t) that disables raw output or compresses into symbolic abstract form before downstream processing.

[208] The engine of [207], wherein private-state triggers include gestures, loiter time exceeding threshold T_priv, or entrance into designated privacy subzones.

[209]A policy zoning DAG engine comprising:
(a) a symbolic zoning graph Z_building(x) mapping spatial layout to programmable behavioral rules, access privileges, and consent requirements;
(b) a capsule router R_policy(x,t) that directs symbolic capsule flow across zone boundaries while enforcing zone DAG constraints;
(c) a symbolic treaty stack S_jurisdictions(x) supporting region-specific override, consent fallback, or escalation bans.

[210] The system of [209], wherein zoning graphs are anchored cryptographically and revalidated at each capsule hop.

[211]A symbolic human-agent collaboration system comprising:
(a) a feedback glyph engine G_coach(x,t) dispatching advisory symbols to staff based on real-time DAG motifs;
(b) a symbolic intent resolver I_loop(t) mapping staff response into updated capsule feedback paths;
(c) a continuous improvement DAG D_refine(x) encoding gesture-consequence associations for future behavior coaching without raw video replay.

[212] The system of [211], wherein each feedback cycle closes within time window T_coach≤1.2 s and is stored symbolically with a relevance decay curve.

[213]A symbolic disaster detection engine comprising:
(a) a multimodal hazard sensor array H_sensors(t) incorporating vibration, thermal, smoke, and acoustic anomaly classifiers;
(b) a symbolic hazard DAG D_hazard(x) mapping hazard precursors to emergency behavior motifs and zone-wise response triggers;
(c) a symbolic evacuation capsule C_evac(x,t) routing real-time agent instructions across policy DAGs and consent overlays.

[214] The engine of [213], wherein DAG motif classification initiates preemptive HVAC deactivation, door unlocks, and light-guided routing without human confirmation.

[215]A voice-anonymized fire alarm system comprising:
(a) a symbolic audio preprocessor A_filter(x) that strips biometric voiceprint tokens and converts detected “help” or “fire” phrases into normalized intent capsules;
(b) a gesture-confirmation module G_verify(x,t) requiring motion-based distress validation to confirm alert;
(c) a symbolic relay capsule C_alert(x) that dispatches incident state to zone policy DAG with escalation metadata but without voice payload.

[216] The system of [215], wherein distress is confirmed if simultaneous audio intent+heat spike+erratic gesture capsule are observed within time T≤1.4 s.

[217]A symbolic simulation module for behavioral capsule testing comprising:
(a) a capsule injection engine C_sim(x) that deploys synthetic behavioral DAGs into inactive zones to validate rule alignment, tolerance thresholds, and privacy deflection capacity;
(b) a trust field metric T_field(x,t) indicating zone-level resilience to anomaly classification drift under synthetic capsule injection;
(c) a DAG regression engine D_relearn(t) that updates zone DAG tolerances based on mismatch entropy between expected and symbolic replay outcome.

[218] The module of [217], wherein simulation tests are non-retentive and redacted automatically post-validation.

[219]A gesture-based HVAC override system comprising:
(a) a symbolic override gesture class G_HVAC(x) including raise-arm-hold, double-wave, or circular motion;
(b) a proximity-weighted confirmation engine P_HVAC(t) ensuring gestures are from occupants within comfort control radius;
(c) an override DAG node D_override(t) that temporarily suspends automated thermal behavior DAG rules and assigns capsule control to human.

[220] The system of [219], wherein override duration decays exponentially unless re-confirmed with secondary gesture G_confirm(x,t) within 90 seconds.

[221]A symbolic occupancy drift detection module comprising:
(a) a dynamic capsule clustering engine C_drift(x,t) that calculates occupancy deviation vectors based on predicted DAG paths vs. actual capsule sequences;
(b) a trust decay metric T_drift(z,t) per zone z where deviation exceeds symbolic behavior tolerance windows;
(c) an automated capsule realignment module R_align(x) that interpolates between prior motif weightings and observed motion vectors.

[222] The module of [221], wherein re-clustering initiates only if cumulative trust decay ΣT_drift(z) across connected zones exceeds a predetermined threshold θ_drift.

[223]A symbolic capsule reweighting framework for DAG stabilization comprising:
(a) a behavior entropy scoring module S_entropy(x) that tracks gesture/posture unpredictability across temporal windows;
(b) a reweighting node W_dag(n) that modifies forward-momentum weights of symbolic transitions in behavior DAGs;
(c) a policy-anchored decay lock L_policy(x) that prevents override of certain security/emergency transitions during reweighting.

[224]A symbolic insurance relay DAG comprising:
(a) a real-time risk capsule relay C_risk(t) configured to transmit symbolic summaries of hazard, anomaly, or injury without biometric traces;
(b) a DAG compression unit D_risk(t) that clusters observed hazard motifs into pre-encoded insurance protocol sequences;
(c) a consent-locking key K_consent(x) that controls whether personal identifiers were redacted prior to capsule transmission.

[225] The system of [224], wherein coverage status is dynamically embedded via symbolic tags derived from recent compliance gesture sequences (G_compliance(x)).

[226]A symbolic emergency treaty chain engine comprising:
(a) a multi-party DAG encoder D_emergency(x) that establishes joint-response templates between fire, health, and law enforcement authorities;
(b) a symbolic validation chain V treaty(x) verifying each actor's data retention, privacy thresholds, and response window commitments;
(c) a treaty breach capsule B_capsule(x,t) that activates upon unmet response obligations or expired consent fields.

[227] The system of [226], wherein treaty activation is stored with distributed timestamp anchors across edge nodes to ensure tamper-proof regulatory review.

[228]A neural HVAC compression module for symbolic field environments, comprising:
(a) a behavior-to-thermal mapping unit B_temp(z,t) that encodes motion clusters, metabolic signatures, and predicted occupancy into latent thermal vectors;
(b) an edge-deployed autoencoder E_HVAC(x) trained to minimize loss between symbolic behavior features and HVAC actuation sequences;
(c) a drift correction comparator C_HVAC(t) that re-aligns neural outputs based on real-time zone feedback vs. historical ideal delta profiles.

[229] The module of [228], wherein the loss function L_zone(t) is penalized for over-conditioning in privacy-prioritized zones.

[230]A symbolic elevator orchestration system, comprising:
(a) a multi-zone capsule queue Q_lift(x) containing predicted floor transitions based on gesture, urgency, and social proximity vectors;
(b) a consent-flag-aware routing module R_lift(t) that suppresses assignments violating known personal avoidance constraints;
(c) a symbolic flow controller F_lift(n) that schedules vertical travel of capsules with energy-aware routing and shared DAG patterns.

[231] The system of [230], wherein entropic anomalies (e.g., unpredicted panic gestures or loitering) trigger a symbolic lift-reversal capsule C_rev(x) broadcast to override mechanical instruction within permitted safety bounds.

[232]A secure redaction lattice network for edge-symbolic systems, comprising:
(a) a lattice graph L_redact(x,t) encoding per-node access rules, symbolic tag compliance levels, and dynamic redaction thresholds;
(b) a tokenized selector module S_redact(x) that computes redaction sequences in real-time prior to egress or actuation;
(c) a privacy-anchored rollback stack R_stack(t) enabling symbolic reversal of egress decisions within a programmable window.

[233] The lattice of [232], wherein lattice nodes represent composite symbolic classes across privacy zones, occupation types, and active treaty states.

[234]A symbolic DAG patching module comprising:
(a) a feedback ingestion loop F_patch(x,t) derived from edge events, capsule entropy mismatches, and anomaly replay sequences;
(b) a constraint validator V_patch(n) that prevents patch applications violating hardcoded treaty terms or emergency fallback constraints;
(c) a signed patch capsule C_patch(t) broadcast to peer nodes for trust-anchored DAG update propagation.

[235]A symbolic acoustic event prediction module comprising:
(a) an array A_sonic(n) of edge microphones calibrated to distinguish tonal gesture artifacts, sub-threshold utterances, and pattern-of-life anomalies;
(b) a real-time symbolic feature encoder E_sonic(x) mapping acoustic capsules to glyph classes such as stress signals, urgency vocalization, or acoustic hesitation;
(c) a dynamic signature repository R_sonic(t) trained on localized soundscapes with timestamp-linked occupancy consensus.

[236] The module of [235], wherein E_sonic(x) suppresses classification for individuals with revoked consent tokens or in privacy-priority DAG branches.

[237]A symbolic emergency mesh consensus module comprising:
(a) a localized DAG mesh M_em(x,t) propagating multi-node emergency classification capsules across edge compute zones;
(b) a consensus resolver R_mesh(z) that computes weighted trust scores across sensor redundancy for event confirmation without cloud interaction;
(c) a symbolic escalation capsule C_em(z) issued when DAG-mesh quorum exceeds an urgency threshold θ_em.

[238] The module of [237], wherein DAG quorum is timestamped and anchored to immutable audit blocks for ex post compliance verification.

[239]A zero-redundancy cross-zone energy loop system comprising:
(a) an inter-zone energy feedback mesh E_loop(z) routing HVAC or lighting surplus based on symbolic occupancy decay projections;
(b) a loss estimator L_loop(z) computing energy drain vs. symbolic presence decay in neighboring zones;
(c) a priority scheduler P_loop(t) that pre-allocates conditioning cycles to high-confidence occupancy clusters while nullifying void capsule areas.

[240] The system of [239], wherein energy control signals are redacted in real-time when symbolic thresholds denote observed activity not exceeding thermal or safety margins.

[241]A symbolic DAG audit sink module comprising:
(a) a rolling DAG capsule capture buffer B_sink(t) storing pre-redaction symbolic sequences;
(b) a consent-segmented archival index I_sink(x) partitioning audit trails by participant type and treaty domain;
(c) a sink controller C_sink(z) that enforces expungement routines upon capsule lifecycle entropy convergence.

[242] The module of [241], wherein redacted DAG sink contents are replayable only under dual-signed consent token override and supervisory quorum.

[243]A symbolic occupancy gradient vector field module comprising:
(a) a dynamic field generator V_occ(x,y,t) computing real-time occupancy likelihood gradients across a spatial floorplan grid;
(b) a transition predictor T_occ(x±1,y±1,t+1) using prior symbolic capsules to forecast occupant movement across zones;
(c) an anomaly detector A_occ that raises symbolic uncertainty glyphs when occupancy vectors contradict learned pattern DAGs.

[244] The module of [243], wherein V_occ incorporates thermal residual decay and motion echo duration as modifiers to vector magnitude.

[245]A feedback-curated symbolic DAG library system comprising:
(a) a modular DAG repository L_dag(n) that stores behavioral subgraphs indexed by semantic motif clusters;
(b) a feedback loop engine F_dag(t) that promotes or suppresses DAG motifs based on false-positive feedback from redacted event capsules;
(c) a cross-domain inheritance module I_dag that transfers motif weights from similar building types or jurisdictional contexts.

[246] The system of [245], wherein DAG motif suppression requires quorum agreement across at least m=3 feedback vectors from distinct symbolic processing units.

[247] An edge-energy treaty arbitration system comprising:
(a) an energy rights register R_energy(z) representing symbolic treaties between HVAC, lighting, and auxiliary systems per zone;
(b) an arbitration engine A_energy(t) that resolves overconsumption or violation disputes using symbolic priority rules and treaty hierarchy graphs;
(c) a compliance scoring module C_energy(z) that emits treaty-consistency scores and alerts facilities managers of violations.

[248] The system of [247], wherein arbitration decisions are logged as zero-knowledge proofs and timestamped in an edge-local ledger.

[249] An emergency glyph override encoding system comprising:
(a) a compressed glyph override buffer B_glyph(t) preloaded with emergency symbolic capsules and policy-exempt trigger DAGs;
(b) an activation module M_glyph(z) that forcibly overrides zone privacy treaties upon detection of life-safety glyph motifs;
(c) a rollback ledger L_glyph(t) that annotates post-emergency review requirements and records override scope boundaries.

[250] The system of [249], wherein emergency glyph overrides are auditable and subject to retroactive privacy restitution per jurisdictional compliance DAG.

[251]A symbolic HVAC risk heat index module comprising:
(a) a sensor fusion input S_hvac(t) aggregating symbolic heat capsule histories, CO₂ levels, motion stasis patterns, and humidity deltas;
(b) a dynamic symbolic risk vector R_hvac(x,y) computed from thermodynamic stress motifs, congestion glyph overlays, and air turnover lag profiles;
(c) a predictive escalation engine E_hvac(t+Δt) that estimates thermal hazard progression and initiates capsule-based rerouting of occupants.

[252] The module of [251], wherein zones with stale symbolic air capsules over threshold time T_max trigger real-time glyph dispatch to override ventilation treaties.

[253]A consent-redacted optics controller comprising:
(a) a live optics manager O_ctrl that dynamically adjusts FOV (field-of-view), aperture, and blur masks based on symbolic privacy capsules;
(b) a pixel stream redactor P_mask that computes redaction overlays from DAG-based identity obfuscation treaties;
(c) a cryptographic actuator C_optics that irreversibly discards prohibited content before sensor data leaves the lens housing.

[254] The system of [253], wherein symbolic gesture proximity triggers real-time optical zoning, adjusting lens parameters within 250 ms edge latency.

[255]A zero-knowledge trait mapper comprising:
(a) a biometric suppression kernel B_sup that receives motion, thermal, and skeletal embeddings without constructing ID tokens;
(b) a symbolic trait encoder T_sym that translates detected features into non-reversible symbolic traits (e.g., posture, urgency, tempo);
(c) a cryptographic capsule linker ZK_link that logs proof-of-observation without associating with any deterministic biometric vector.

[256] The trait mapper of [255], wherein symbolic traits are stored as entropy-ranked glyph capsules in local secure enclaves.

[257]A building-to-building symbolic mesh relay logic comprising:
(a) a consent-bound relay node R_mesh that filters interbuilding capsule relays based on treaty alignment and jurisdiction constraints;
(b) a mesh trust graph G_trust(n) that scores buildings' symbolic behavior fidelity over time, optimizing relay routing paths;
(c) a capsule merger C_merge that merges structurally similar glyph packets across buildings to form regional pattern DAGs.

[258] The relay logic of [257], wherein DAG capsules above threshold significance trigger reinforcement feedback updates across peer buildings.

[259]A symbolic supply chain overlay module comprising:
(a) an asset presence recognizer A_sym that detects package, crate, or supply pod ingress events without barcode or tag scanning, using motion vector congruency with authorized delivery motifs;
(b) a symbolic receipt capsule generator C_supply that encapsulates delivery traits (tempo, access method, routing path) as glyph states;
(c) a zone-routing module Z_rout that adjusts HVAC, lighting, and personnel proximity rules during and after supply drop events.

[260] The module of [259], wherein unauthorized supply motifs (e.g., reverse route flow or unaccompanied motion capsule) trigger DAG-based anomaly flags and trigger lockdown overlays in real-time.

[261] An actuator-level ethics arbitration layer comprising:
(a) a real-time actuator logic arbiter L_ethic that receives motor commands (e.g., door open, vent seal, floor vibration) and filters them through ethics-aligned DAG nodes;
(b) an override filter F_override that denies execution of symbolic commands when violation of policy treaties is inferred;
(c) a fallback capsule generator C_fallback that logs rejected actuator attempts and sends symbolic guidance to supervisory systems.

[262] The layer of [261], wherein actuator arbitration latency is <120 ms for emergency commands, and capsule rejection logs are permanently hashed in a local audit shard.

[263]A vibration capsule detection system comprising:
(a) piezo or accelerometer arrays V_det(x,y,t) distributed across structural nodes of a building;
(b) a capsule encoder C_vibe that translates vibration patterns into symbolic glyphs representing walking patterns, object drops, stress microfractures, or tampering behavior;
(c) a confidence classifier C_conf that binds entropy levels to vibration motifs, enabling risk escalation without explicit visual detection.

[264] The system of [263], wherein only capsules exceeding risk entropy H_thresh are stored in permanent symbolic ledger, with all others flushed to entropy buffer stack.

[265]A code-free treaty composer interface comprising:
(a) a visual symbolic graph editor V compose allowing domain owners to draw policy overlays via node-link DAGs representing access, consent, risk, and escalation;
(b) a capsule simulator Sim_treaty that lets users test capsule flows through the graph to preview override, redaction, or escalation results;
(c) a secure compiler T_compile that serializes the symbolic DAG into edge-executable treaty maps deployed to local enclaves.

[266] The interface of [265], wherein updates to treaties are version-controlled and cryptographically signed by building-level stewards with replay protection.

[267]A gesture anomaly oracle module comprising:
(a) a symbolic gesture library G_ref stored locally, consisting of templated movement capsules segmented by intent-class: service, inquiry, panic, theft, duress;
(b) a real-time comparator G_diff that evaluates live occupant movement patterns G_live(x,y,t) against G_ref, computing vector residuals and time-phase misalignments;
(c) a symbolic escalation controller G_flag that raises entropy tier only if deviation exceeds entropy delta threshold ΔH_g>θ.

[268] The module of [267], wherein anomaly scoring is made invariant to individual gait, clothing occlusion, or time-of-day by using symbolic trajectory momentum fields instead of raw coordinate paths.

[269]A multi-floor capsule routing system comprising:
(a) a vertical topology map F_map representing inter-floor conduit geometry, elevator shafts, stairwell adjacency, and null-zones;
(b) a capsule relay node C_lift that tracks vertical transit events and reassigns capsule ownership across edge node clusters as users traverse floors;
(c) a symbolic consensus layer C_sync that ensures gesture-to-policy alignment even when building-level treaty overlays differ per floor.

[270] The system of [269], wherein capsule handoff logs include floor height, vertical acceleration, directional drift, and delay tolerances, cryptographically signed and sealed per transition.

[271] An occupant submodularity estimator comprising:
(a) a behavior entropy aggregator E_occ that computes per-user symbolic sparsity scores over time S user(t), defined as inverse capsule redundancy;
(b) a zone occupancy decomposer Z_occ that estimates non-overlapping behavior cluster sets from shared symbolic pathways, identifying latent social edges;
(c) an efficiency index I_mod that maps symbolic entropy divergence against energy usage in those zones, flagging inefficiencies due to overactive routing or comfort mismatch.

[272] The estimator of [271], wherein optimization recommendations are rendered symbolically (e.g., “High entropy pair near north HVAC shaft”) and exported to local building dashboards.

[273] An airflow-behavior synchronization grid comprising:
(a) a dynamic airflow vector field A_field(x,y,z,t) mapped to gesture capsule flow and dwell zones;
(b) an anomaly coupling engine A_sync that detects divergence between expected human occupancy-driven airflow patterns and actual HVAC response;
(c) a mitigation capsule C_vent that injects symbolic patch commands into the airflow controller DAG to correct for comfort anomalies without identifying specific individuals.

[274] The grid of [273], wherein symbolically assigned airflow zones include comfort entropy buffers that prevent overcorrection during transient gesture spikes (e.g., in panic or protest scenarios).

[275] An acoustic symbol entanglement module comprising:
(a) a real-time acoustic analyzer A_listen receiving waveform slices w(t) across voice, impact, mechanical, and ambient ranges;
(b) a symbolic convergence engine A_bind that fuses w(t) with co-occurring gesture capsules G(t) and thermal deltas T(t) to construct multimodal behavior motifs;
(c) an entanglement score E_score computed per motif, used to distinguish ambiguous audio events (e.g., dropped object vs. collapse) via capsule correlation strength.

[276] The module of [275], wherein A_bind uses temporal entanglement bands with symbolic weights trained from building-specific event logs to localize anomalies without identifying speakers.

[277]A panic-proximity envelope generator comprising:
(a) a symbolic crowd motion tracker C_flow that detects directional convergence, speed variance, and entropy spikes;
(b) a proximity stress model P_env that calculates real-time symbolic stress envelopes S(x,y,t) around high-risk gestures (e.g., fleeing, cowering, barricading);
(c) a broadcast-trigger B_emit that triggers zone-level emergency response overlays when the envelope diameter exceeds threshold D>θ_panic.

[278] The generator of [277], wherein the stress envelope is dynamically routed through building topologies with null-zone exclusions and ventilation path consideration.

[279]A DAG snapshot vault comprising:
(a) a programmable interval vault controller V_snap that cryptographically stores compressed symbolic DAGs DAG(t_i) with entropy-tier filters;
(b) a trust anchor T_seal that signs each snapshot with zone, capsule type, and consent-level metadata;
(c) an audit interface A_query that provides redacted, policy-compliant replay access to authorized third parties without revealing raw behavioral data.

[280] The vault of [279], wherein DAG snapshots are compressed using motif frequency histograms and hashed subtree indexing for ultra-low storage overhead.

[281]A redaction preemption mesh comprising:
(a) a multi-agent mesh M_grid of symbolic processors located at sensor junctions, each executing pre-consent redaction rules R(x) before data enters the building's main bus;
(b) a symbolic synchronization bus S_sync ensuring global privacy invariants even during network segmentation;
(c) a rollback safety latch R_latch that halts symbolic capsule propagation if mesh-wide redaction conflict is detected.

[282] The mesh of [281], wherein R(x) is locally unique per junction based on sensor type, position, and policy-grade, and can be updated by building treaty changes without firmware redeployment.

[283]A symbolic vent looping detector comprising:
(a) an airflow topology graph G_vent(x,y,z) modeled from HVAC duct structure and vent junction nodes;
(b) a symbolic anomaly forwarder S_loop that traces behavioral capsules C_sym(t) routed via airflow detection zones;
(c) an inverse risk scoring engine R_inv that estimates indirect exposure risk or behavioral echo based on capsule density and symbolic vector decay across G_vent.

[284] The detector of [283], wherein symbolic capsules carry an “aeromask” attribute encoding environmental trace congruence, enabling retroactive path filtering of airborne anomalies or heat-based capsule shadows.

[285]A visitor capsule quarantine system comprising:
(a) a dynamic ingress-class detector V_scan that identifies new symbolic capsule signatures unlinked to registered building residents;
(b) a behavioral sandbox Q_zone which restricts capsule propagation from visitor-linked agents into full symbolic graph ingestion until validation;
(c) a containment ledger L_hold logging all visitor capsules C_v(t) with their originating port, symbolic summary, and decay countdown.

[286] The system of [285], wherein validation is governed by a building-specific consent treaty tree that includes jurisdictional clauses, tenant override rights, and capsule degradation timers.

[287]A temporal smoothing relay module comprising:
(a) a buffer zone B_temp that collects symbolic behavior capsules C(t) across adjacent spatial zones Z_i and Z_j;
(b) a symbolic time-gradient harmonizer T_blend that adjusts capsule sharpness or escalation curves across zone boundaries to reduce false alarms from edge-transition behavior;
(c) a proximity hysteresis controller H_slow that delays motif elevation if prior capsule entropy E_prev(t−Δ) remained below trigger level.

[288] The relay module of [287], wherein T_blend maintains symbolic coherence across zone shifts by aligning capsule motif frequency harmonics over a rolling window W_r.

[289]A predictive entropy budgeting engine comprising:
(a) a symbolic entropy accumulator E_hist that tracks cumulative entropy budget ΣE(t) per zone and behavior class;
(b) a forecasting kernel F_pred that estimates future entropy spikes based on time of day, occupancy profile, and prior motif volatility;
(c) a preemption allocator A_cutoff that rebalances surveillance attention or symbolic sensitivity thresholds in anticipation of budget overflow.

[290] The engine of [289], wherein entropy budget rebalancing is used to defer non-critical surveillance capture, prioritize capsule retention, or dynamically upgrade motif compression based on storage availability and legal treaty constraints.

[291]A symbol-encoded HVAC actuation module comprising:
(a) a symbolic gesture-to-temperature map M_temp{S_glyph}linking zone-specific posture motifs to thermal profile adjustments;
(b) a DAG-bound modulation engine H_act configured to resolve motif intensity sequences into vent actuation commands with temporal tapering;
(c) a feedback convergence loop F_loop using symbolic entropy gradients to fine-tune HVAC oscillation suppression.

[292] The module of [291], wherein thermal decisions are prioritized by symbolic class (e.g., stress→cooling bias; drowsiness→CO₂ increase alerts), without identifying specific occupants.

[293]A DAG-governed alarm cascade engine comprising:
(a) a symbolic incident DAG D_inc with escalation nodes linked to motif density, cross-zone propagation velocity, and treaty breach classes;
(b) a redacted alert formatting layer R_alert that substitutes raw visuals with symbolic summaries for compliance;
(c) an activation sink A_final that locks DAG branches and triggers outbound signal routing only upon consent-verification or law-class override.

[294] The engine of [293], wherein alarm messages include symbolic overlays suitable for downstream AI agents, compliance officers, or robotic responders, enabling autonomous emergency interpretation.

[295]A zonal null-certificate enforcement unit comprising:
(a) a null-zone mapper Z_null that registers locations with legal or user-mandated non-surveillance privileges (e.g., restrooms, prayer rooms);
(b) a capsule erasure trigger E_cutoff activated by positional drift into Z_null boundary;
(c) a signature hash invalidator H wipe removing capsule cryptographic continuity, effectively rendering it untraceable and unreconstructable post-deletion.

[296] The unit of [295], wherein entrance into a null zone causes redaction at both memory level and DAG lineage, with capsule hash traces omitted from ledgers.

[297] An emergency capsule bypass latch comprising:
(a) a physical or symbolic override sequence B_latch that unlocks normally redacted motifs in cases of life-threatening events;
(b) a treaty-compliant logging protocol T_emit which requires encrypted output anchoring, third-party witness co-signature, and post-incident review stamp;
(c) a single-use destruction switch D_seal that permanently destroys raw data after capsule replay has fulfilled its emergency-use role.

[298] The latch of [297], wherein capsule replay duration is constrained to ΔT_emergency, after which all active copies are forcibly decomposed.

[299]A sub-symbolic drowsiness inference module comprising:
(a) a micro-motion analysis engine M_micro configured to detect low-amplitude tremor, head-nod rate, and blink irregularity from optical and ToF data streams;
(b) a symbolic state classifier S_drowse that maps time-weighted micro-motion aggregates to a drowsiness motif DAG D_drowse;
(c) a safety threshold θ_safety wherein prolonged D_drowse node persistence triggers alert glyph dispatch or ambient adjustments (e.g., lighting boost, haptic floor cue).

[300] The module of [299], wherein no biometric identity is processed, and only behavior vector derivatives are retained post-inference.

[301]A polyzone behavioral fusion engine comprising:
(a) a cross-zone symbolic synchronizer Z_sync that merges multiple occupant motif sequences across adjacent zones (e.g., hallway→lobby→elevator);
(b) a spatiotemporal motif correlator M_fuse that identifies multi-person behavioral convergence or divergence patterns;
(c) a fusion verdict layer F_verdict which outputs symbolic tags such as “loitering loop,” “cooperative handoff,” or “dispersed evasion” for further DAG escalation logic.

[302] The engine of [301], wherein DAG outputs are constrained by per-zone consent rules, ensuring compliance even under shared pattern convergence.

[303]A thermal entropy signature reconstructor comprising:
(a) a heat trail memory H_path storing low-resolution temporal thermal gradients across a surface grid;
(b) an entropy resolver E_resolve that infers recent human passage, lingering, or anomalies from dissipating heat patterns, without optical confirmation;
(c) a symbolic thermal event capsule C_thermal generated when patterns deviate from registered motifs (e.g., collapsed occupant, fire source).

[304] The reconstructor of [303], wherein entropy thresholds are linked to time-decay functions calibrated per material and zone insulation parameters.

[305]A gesture-fault recovery chain comprising:
(a) a redundant gesture detection path G_redun comprising both optical and acoustic correlation models;
(b) a failure detection module F_detect that triggers if glyph formation is incomplete or occluded;
(c) a symbolic repair circuit S_repair that estimates probable intended gesture via n-gram motif continuity in a rolling context DAG.

[306] The chain of [305], wherein estimated gestures are soft-labeled with trust coefficients and flagged for optional DAG-anchored audit later.

[307]A multi-agent capsule arbitration module comprising:
(a) an arbitration kernel K_arb that receives symbolic capsules from distributed agents operating in overlapping zones;
(b) a context resolver C_res which resolves conflict when capsule interpretations diverge (e.g., panic vs. sprint);
(c) a tie-breaking engine T_break which applies historical motif reliability scores and zone privilege hierarchy to resolve capsule outcomes.

[308] The arbitration module of [307], wherein agent nodes are assigned confidence weights based on historical anomaly detection precision and consent adherence logs.

[309]A legal-jurisdiction forking protocol comprising:
(a) a symbolic capsule metadata header H_fork tagging capsules with local, national, and sectoral compliance classes;
(b) a forking engine F_jur that branches DAG storage paths and audit trail formats based on jurisdictional logic (e.g., GDPR vs. HIPAA);
(c) a treaty compliance anchor T_anchor that hashes all forks to a single root ledger while preserving separation for export and subpoena logic.

[310] The protocol of [309], wherein each jurisdictional fork can be cryptographically detached or embargoed during policy renegotiation.

[311]A consent-chain compression module comprising:
(a) a symbolic chain encoder E_chain that compresses repeated consent-confirmed motifs into lossless signature blocks;
(b) a chain entropy analyzer A_entropy that detects periods of redundant behavior and permits segment pruning from active recall DAGs;
(c) a compliance-safe replay generator R_gen that reconstructs symbolic behavior timelines without redundant consent-resolution delays.

[312] The module of [311], wherein compression ratios and recall logic are controlled by user-settable privacy budgets encoded in token metadata.

[313]A symbolic fire-evacuation capsule constructor comprising:
(a) a multimodal emergency motif detector M_fire detecting heat spikes, motion dispersion, and stress-patterned acoustics;
(b) a symbolic evacuation DAG D_evac which maps occupant dispersal vectors to optimal exit motifs;
(c) a broadcast glyph engine G_broadcast that emits symbolic exit guidance overlays in real-time on wall panels, AR lenses, or haptic floor patterns.

[314] The capsule of [313], wherein occupants with mobility impairment tokens are prioritized in the DAG and generate adaptive reroute motifs visible to nearby agents.

[315]A symbolic HVAC memory system comprising:
(a) a long-term symbolic state buffer S_HVAC logging historical capsule conditions correlated with thermal setpoint outcomes;
(b) a motif-coalescing layer M_HVAC that collapses recurring occupant behaviors (e.g., group entry→window close→temperature spike) into HVAC intent capsules;
(c) a predictive actuator interface A_pred that adjusts airflow, humidity, and zone temperature using symbolic cues without biometric identity.

[316] The system of [315], wherein symbolic capsules are weighted against outdoor condition projections, occupancy load vectors, and entropy variance trends.

[317]A sleep-occupancy recognition capsule generator comprising:
(a) a symbolic classifier C_sleep trained on low-motion body posture vectors, respiration-pattern acoustics, and ambient thermal plateaus;
(b) a redacted gesture handler G_block that blocks high-priority alert escalation if occupants are symbolically tagged as unconscious or sleeping;
(c) a DAG deviation monitor D_sleep that triggers wake-mode if anomalous motion/temperature vectors emerge from the sleep-state capsule boundary.

[318] The generator of [317], wherein sleep-state detection updates symbolic HVAC parameters to reduce airflow noise and maintain thermoneutrality.

[319]A treaty-class capsule expiry handler comprising:
(a) a treaty-timer register T_reg that tags each capsule with a programmable expiry window derived from jurisdictional compliance classes;
(b) a symbolic decay engine E_decay that begins staged anonymization, entropy insertion, and gesture de-linking once treaty expiry thresholds are met;
(c) a ledger pruning module L_prune that emits compliance-proof metadata to treaty audit chains post-expiry.

[320] The handler of [319], wherein capsule expiry can trigger optional end-user consent renewal glyphs in AR, signage, or ambient haptics.

[321]A symbolic anti-theft capsule engine comprising:
(a) a symbolic motif predictor M_theft detecting patterns like object concealment, proximity obfuscation, anomalous exit pacing, and group distraction tactics;
(b) a capsule conflict resolver R_conflict that flags DAGs for review only if symbolic consent class is “customer” and not “employee”;
(c) a symbolic lockdown protocol P_lock that transmits an internal glyph to staff endpoints or environmental actuators (e.g., close doors) without activating facial ID or alarms.

[322] The engine of [321], wherein symbolic motifs are continuously re-ranked based on adversarial mimicry detection and real-world feedback tags (false-positive resolution capsules).

[323]A symbolic insurance compliance capsule system comprising:
(a) a DAG ledger interface D_insure tagging symbolic events with incident severity, party class (staff/customer), and safety compliance alignment;
(b) a claim abstraction module C_abstract that converts symbolic capsules into risk-weighted tokens usable for automated insurance claims;
(c) a capsule dispute resolution layer R_dispute that allows third-party insurance validators to audit anonymized symbolic traces via consent anchor proofs.

[324] The system of [323], wherein symbolic gesture DAGs are cross-referenced with pre-registered store insurance policies and compliance treaty thresholds.

[325]A smart window capsule interface comprising:
(a) a symbolic opacity control engine E_opacity that modulates glass tint based on internal occupancy class, ambient light vectors, and privacy treaty triggers;
(b) an emergency override relay R_window that clears opacity when emergency capsules breach threat thresholds (e.g., fire, physical altercation);
(c) a symbolic consent display D_glass projected as glyphs within smart glass for passive consent updates.

[326] The interface of [325], wherein tint control and consent glyphs are redacted and stored as capsules for later compliance audit and incident reconstruction.

[327] An acoustic entropy fingerprinting module comprising:
(a) a microphone array M_acoustic that converts ambient audio patterns into symbolic entropy fields without speech reconstruction;
(b) a symbolic anomaly classifier A_entropy that detects irregular motion or aggression through high-frequency amplitude variation and vector tension shifts;
(c) a redaction engine R_audio that purges any sound resembling speech or biometric identity prior to DAG injection.

[328] The module of [327], wherein entropy fields are aligned with gesture motifs to increase predictive confidence without facial or voiceprint use.

[329] An emergency simulation capsule system comprising:
(a) a capsule generation simulator S_emergency that creates hypothetical symbolic DAGs for fire, theft, or collapse scenarios using synthetic gesture timelines;
(b) a symbolic actuator tester T_actuator that dry-runs capsule-triggered environmental responses (e.g., unlock exits, trigger glyph signs) without live deployment;
(c) a treaty impact estimator E_treaty that scores each simulated capsule's policy compliance, false-positive risk, and safety overlap.

[330] The system of [329], wherein simulated DAGs can be merged into live system training via tagged synthetic inputs and override-class memory slots.

[331]A cross-building symbol exchange protocol comprising:
(a) a symbolic broadcast layer L_sync that enables gesture-class capsule sharing across geographically distributed nodes (e.g., retail chains, campuses);
(b) a context-aware gate G_site that filters incoming capsules based on site policy, occupancy class, and treaty alignment;
(c) a symbolic convergence module C_unify that learns transferable motifs by aligning shared DAGs with local gesture entropy fields.

[332] The protocol of [331], wherein high-confidence safety or threat motifs are prioritized for low-latency broadcast and optionally merged into local risk forecasting models.

[333]A blockchain-anchored capsule system comprising:
(a) a hash generation engine H_capsule that creates cryptographic digests of symbolic behavior capsules;
(b) a ledger writing module W_anchor that immutably records capsule hashes with policy DAG state and consent metadata on a distributed blockchain network;
(c) a replay validator V_chain that verifies tamper-proof replay of events against the originally committed symbolic sequences.

[334] The system of [333], wherein policy changes are version-controlled on-chain and each capsule references the exact policy DAG state used at time of capture.

[335]A symbolic emotion detection engine comprising:
(a) a gesture-to-affect converter G_affect that infers emotional states (e.g., stress, confusion, frustration) from micro-movement sequences and symbolic delay vectors;
(b) an emotional threshold map T_emotion that determines consent-triggered escalation pathways based on affect level and role class (e.g., customer, employee);
(c) a redaction pipeline P_feel that obfuscates affect tokens unless aligned with DAG severity protocols or authorized playback consent.

[336] The engine of [335], wherein emotion inference operates entirely on symbolic derivatives of movement, posture, and spatial resistance, without biometric reconstruction.

[337]A multi-zone DAG synchronization protocol comprising:
(a) a zone classifier Z_split that assigns symbolic capsules to dynamically defined zones based on behavioral density, structural layout, and gesture type entropy;
(b) a DAG resolver R_merge that manages transitions between zones, merging subgraphs while preserving zone integrity and symbolic priority threads;
(c) a capsule reweighter W_sync that adjusts symbolic capsule entropy scores based on inter-zone conflicts, escalation probabilities, and override rules.

[338] The protocol of [337], wherein zone topology adapts in real-time to crowd flow and symbolic motif migration to prevent priority deadlocks.

[339]A capsule fusion layer comprising:
(a) a symbolic convergence engine E_fuse that aggregates redundant or convergent behavioral capsules into composite capsule bundles based on semantic DAG overlap and entropy thresholds;
(b) a temporal stitching module M_stitch that aligns event fragments across time gaps, unifying partial gestures into coherent symbolic motifs;
(c) a retention policy handler R_hold that determines capsule lifespan based on fusion value, redundancy class, and treaty-linked relevance.

[340] The fusion layer of [339], wherein capsule bundles are tagged with dynamic trust weight scores, replay permissions, and override-safe hashes.

[341]A symbolic patent dependency indexer comprising:
(a) a DAG comparison engine D index that compares symbolic flow graphs across multiple deployed environments to identify patent-bound execution motifs;
(b) a citation token generator T_cite that annotates capsules and software elements with dependency relationships to prior patented DAGs;
(c) a conflict arbitration layer A_patent that flags non-compliant deployments and recommends rerouting to non-infringing motifs.

[342] The indexer of [341], wherein real-time deployments are audited for dependency violations across symbolic capsules, gesture lexicons, and policy overlays.

[343]A cross-jurisdictional compliance tree comprising:
(a) a region-aware policy tree T_reg that maps each symbolic action and consent trigger to jurisdiction-specific legality, privacy scope, and retention mandate;
(b) a DAG-compliance synchronizer S_juris that rewrites symbolic policies at runtime to comply with overlapping national, municipal, and organizational standards;
(c) an audit-ready ledger L_compliance that logs all DAG edits, capsule redactions, and cross-border policy transitions in cryptographic format.

[344] The compliance system of [343], wherein multi-nation deployments dynamically adjust redaction protocols, capsule entropy visibility, and escalation triggers based on compliance DAGs.

[345]A symbolic energy budgeting system comprising:
(a) a gesture-energy model G_budget that estimates compute and sensing energy cost per symbolic capsule class;
(b) a DAG-prioritizer P_throttle that modulates processing intensity, sensor duty-cycle, and symbolic retention based on energy constraints and behavior criticality;
(c) an entropy-energy optimizer O_balance that maximizes symbolic accuracy per watt, factoring in capsule density, edge-device thermal limits, and privacy overhead.

[346] The system of [345], wherein symbolic execution adapts dynamically to power constraints (e.g., battery-only operation, blackout fallback) without degrading DAG integrity or violating consent-trigger rules.

### BRIEF DESCRIPTION OF THE DRAWINGS (UANF PATENT)

The following 20 figures illustrate key components, signal flows, and structural configurations of the Universal Ambient AI Neural Field (UANF) system, designed for edge-based, symbolic AI governance of built environments.

[FIG. 1]—Building-Level UANF System Architecture

A high-level block diagram showing the integration of edge compute nodes, sensor clusters (thermal, acoustic, visual), symbolic DAG engine, and building actuation systems (HVAC, lighting, alarms). Modular design depicts internal and external data flows.

[FIG. 2]—Edge Node Hardware Stack

Exploded view of the edge compute node unit showing thermal shielding, real-time co-processor, symbolic logic circuit board, and interface ports for sensor/facility bus connections.

[FIG. 3]—Symbolic Signal Path Pipeline

Flowchart illustrating sensor signal intake, pre-processing, DAG transformation, entropy grading, symbolic tagging, and feedback loop closure to control systems.

[FIG. 4]—Occupancy Classification Map

Top-down floorplan heatmap illustrating real-time occupant tracking zones by symbolic state (idle, movement, emergency, unauthorized, anomalous).

[FIG. 5]—Energy Prediction DAG

Tree-structured diagram showing hierarchical symbolic breakdown of behavioral patterns leading to forecasted HVAC/lighting adjustments.

[FIG. 6]—Accident Detection Capsule Flow

Flow diagram showing the triggering sequence for fall, fire, gas leak, or seizure detection based on symbolic state transition thresholds and waveform shifts.

[FIG. 7]—Privacy-Compliant Behavior Classifier

Diagram contrasting symbolic pose-based classification with traditional facial recognition pipelines. Highlighted is the anonymized DAG output and zero-identity tagging layer.

[FIG. 8]—Emergency Response DAG Switching

Flowchart detailing symbolic overrides that redirect HVAC, lighting, and exits during fire, earthquake, or armed threat events. Escalation stages shown with DAG branches.

[FIG. 9]—Symbolic Consent Capsule Lifecycle

Lifecycle stages of symbolic consent capsules generated upon behavioral capture. Transitions include: creation, encryption, storage, policy binding, expiry, and redaction.

[FIG. 10]—HVAC Symbolic Interface Adapter

Technical schematic showing the symbolic-to-mechanical translation module that interfaces UANF with legacy HVAC systems, using relay logic and neural intent buffers.

[FIG. 11]—Lighting Optimization via Behavior DAGs

Chart linking symbolic occupancy patterns to lighting adjustments using symbolic entropy as the control parameter for dimming or directional lighting shifts.

[FIG. 12]—Security Anomaly Classifier Tree

Decision tree showing symbolic differentiation of suspicious behavior (loitering, tampering, tailgating) versus normal foot traffic across time and context.

[FIG. 13]—DAG Redaction Ledger Interface

System diagram showing the interaction between symbolic DAG engine, redaction request handler, consent treaty index, and audit ledger cryptographic writer.

[FIG. 14]—Building-Level Sensor Mesh Grid

Topological layout of ceiling-mounted and wall-mounted sensor nodes forming a lattice network across the structure, with coverage radii and blind zone markers.

[FIG. 15]—Emergency Override Control Glyphs

Glyph-based user interface schematic showing symbolic emergency triggers (manual override gestures) mapped to DAG escalation functions and shutdown sequences.

[FIG. 16]—Multi-Zone DAG Conflict Resolver

Illustration of two overlapping symbolic DAGs in adjacent building zones negotiating access to shared HVAC systems via arbitration node and symbolic priority metrics.

[FIG. 17]—UANF Smart Glass Integration Flow

Flow diagram showing symbolic light detection, gesture input, and privacy-aware smart glass opacity modulation via local DAG execution.

[FIG. 18]—Data Minimization Control Circuit

Hardware-level layout of on-chip symbolic filters enforcing edge-only computation and blocking unauthorized outbound data streams. Shown with policy switch wiring.

[FIG. 19]—Predictive Maintenance Symbol DAG

Flowchart of mechanical strain and thermal fluctuation sensors generating symbolic triggers for predictive alerts in elevators, pumps, or boilers.

[FIG. 20]—Cross-Building Symbolic Pattern Sync

System diagram showing multiple buildings' UANF nodes exchanging anonymized symbolic pattern summaries to optimize broader district-level coordination and forecasting.

1. A building-integrated artificial intelligence system comprising:
a distributed multimodal sensor lattice configured to acquire optical, thermal, acoustic, airflow, structural, and electrical state data across a built environment;
a symbolic cognition engine executed on local edge compute hardware and configured to transform said data into occupancy vectors, behavioral glyphs, risk signatures, and environmental state descriptors without generating biometric identity;
a privacy-governed policy graph defining sensor permissions, redaction thresholds, consent conditions, emergency overrides, and jurisdiction-specific compliance rules;
and an adaptive environmental control kernel configured to modulate HVAC, lighting, ventilation, and energy distribution using predicted occupancy, risk, and environmental trajectories derived from said symbolic representations.

2. A method for autonomous building management comprising:
detecting multimodal environmental and occupant conditions via a distributed sensor lattice;
generating symbolic state representations including occupancy vectors, behavioral glyphs, and environmental descriptors;
evaluating said representations against a policy graph encoding privacy constraints and legal compliance rules;
executing HVAC, lighting, airflow, energy, and safety control adjustments using predicted occupancy vectors and symbolic risk states;
and generating a redacted event capsule containing symbolic audit data, lineage markers, and compliance metadata when anomalous or emergency conditions are detected.

3. An edge-compute building node comprising:
a secure enclave processor configured for on-premise execution of symbolic inference;
a symbolic processing module generating non-identifiable behavioral and environmental descriptors;
a hardware-enforced redaction subsystem configured to block or transform protected data prior to any transmission;
a multimodal sensor interface bus;
and a neural-field synchronization module configured to exchange compressed symbolic templates and occupancy vectors with adjacent building nodes.

4. The system of claim 1, wherein occupancy vectors are inferred from thermal and airflow signatures rather than visual identity features.

5. The system of claim 1, wherein the policy graph automatically disables or attenuates specific sensors based on user consent, tenant settings, or jurisdictional mandates.

6. The system of claim 1, wherein behavioral glyphs include movement irregularities associated with medical emergencies, falls, or distress events.

7. The system of claim 1, wherein anomaly detection further comprises identifying structural stress patterns, vibration anomalies, or hazardous air composition deviations.

8. The method of claim 2, wherein symbolic representations are stored or transmitted using entropy-indexed or boundary-condition compression formats.

9. The method of claim 2, wherein HVAC modulation includes predictive pre-conditioning triggered by historical occupancy cycles and time-of-day patterns.

10. The method of claim 2, wherein emergency override conditions dispatch automated alerts to first responders using jurisdiction-compliant symbolic capsules.

11. The device of claim 3, wherein the redaction subsystem physically blocks unauthorized outbound data paths using hardware gating or fused-logic barriers.

12. The device of claim 3, further comprising a power-fail recovery capacitor configured to preserve symbolic templates or policy-graph states during electrical outages.

13. The system of claim 1, wherein neural-field synchronization employs DAG-based template inheritance for distributed pattern updating.

14. The system of claim 1, wherein energy optimization includes localized micro-zone conditioning responsive to sub-room behavioral patterns.

15. The method of claim 2, wherein environmental descriptors include pressure-wave anomalies indicative of door openings, window failure, or mechanical malfunction.

16. The device of claim 3, wherein sensor data is fused through a real-time symbolic attention module prioritizing risk-relevant features.

17. The system of claim 1, wherein predictive occupancy vectors are refined using federated exchange of symbolic templates between multiple buildings.

18. The method of claim 2, wherein event capsules include consent-state markers, policy-graph lineage, and jurisdictional compliance metadata.

19. The device of claim 3, wherein a jurisdiction adaptor module enforces region-specific privacy, retention, and redaction requirements.

20. The system of claim 1, wherein HVAC override commands are constrained by safety envelopes derived from historical entropy profiles and environmental stability thresholds.
